(19) United States
(12) Patent Application Publication
(10) Pub. No.: US 2020/0030833 A1
(43) Pub. Date: Jan. 30, 2020

(54) SPRAY FOAM GUN COVER

(71) Applicant: SprayTech Innovations, Hanna (CA)

(72) Inventors: Joe Upper, Hanna (CA); Christ Stitt, Hanna (CA); Aitor Iruretagoyena, Hanna (CA); Sheri Kellington, Hanna (US); Andy Geck, Hanna (CA); Alexander Nielsen, Hanna (CA); Joey Stitt, Hanna (CA)

(73) Assignee: SprayTech Innovations, Hanna (CA)

(21) Appl. No.: 16/406,685

(22) Filed: May 8, 2019

(30) Foreign Application Priority Data
Jul. 24, 2018 (CA) 3012157

(51) Int. Cl. B05B 12/32

(52) U.S. Cl. CPC B05B 12/32

(57) ABSTRACT

A spray gun cover for protecting a spray gun upper body from overspray is provided. The spray gun cover comprises a cover front wall, a cover rear wall, and a cover center body. The cover front wall is form-fitted to a front portion of the spray gun upper body surrounding a spray nozzle of the spray gun and has a front aperture disposed therein such that the front aperture coincides with the spray nozzle. The cover rear wall is form-fitted to a rear portion of the spray gun upper body. The cover center body is disposed between the cover front wall and the cover rear wall and has a bottom aperture disposed in a bottom portion thereof. The bottom aperture is designed for enabling insertion of the spray gun upper body therethrough into the spray gun cover. The cover front wall, the cover rear wall, and the cover center body are sufficiently pliable and have a sufficient wall thickness for enabling application/removal of the spray gun cover onto/from the spray gun upper body and for ensuring a substantially tight fit: between the cover front wall and the front portion of the spray gun upper body; and between the cover rear wall and the rear portion of the spray gun upper body.

### FIELD OF THE INVENTION

The present invention relates to fluid spray guns, and more particularly to a spray foam gun cover for protecting a spray foam gun upper body from overspray.

### BACKGROUND OF THE INVENTION

Typically, present-day spray foam guns comprise a spray foam gun upper body—with a spray nozzle disposed in a front thereof—and a spray foam gun lower body—with trigger and handle—extending downwardly therefrom. While during spraying the spray foam gun lower body is mostly protected by the spray foam technician's protective clothing, i.e. the gloves, when holding the spray foam gun, the spray foam gun upper body is exposed to a substantial amount of overspray which quickly accumulates over the top, front, and sides thereof, resulting in a substantial build-up of quickly hardening material. In order to keep the spray foam gun operational, the build-up needs to be removed in relatively short time intervals—typically by wiping it off the spray foam gun upper body before it is hardened—during the spraying process, thus interrupting the spraying process numerous times.

While wiping during the spraying process removes most of the overspray, there is still some overspray left on the spray foam gun upper body which quickly hardens. Typically, this hardened overspray is removed at least once a week to keep the spray foam gun in good working condition. For removing the hardened overspray, the spray foam gun is immersed for several hours in cleaning chemicals to neutralize the overspray's adhesive properties. After removal from the cleaning chemicals, the overspray is mechanically removed causing substantial wear and tear.

While attempts have been made to provide a cover for protecting spray guns such as, for example, the cover described in U.S. Pat. No. 5,862,989 (Cirillo), they insufficiently fit to the spray gun, thus still exposing the same, or at least portions thereof, to overspray.

It is desirable to provide a spray foam gun cover for protecting a spray foam gun upper body from overspray that provides a substantially tight fit with the spray foam gun upper body.

It is also desirable to provide a spray foam gun cover for protecting a spray foam gun upper body from overspray that is form-fitted to the spray foam gun upper body of a respective type of spray foam gun.

It is also desirable to provide a spray foam gun cover for protecting a spray foam gun upper body from overspray that is re-usable and allows removal of hardened overspray by bending and/or scraping the spray foam gun cover.

### SUMMARY OF THE INVENTION

Accordingly, one object of the present invention is to provide a spray foam gun cover for protecting a spray foam gun upper body from overspray that provides a substantially tight fit with the spray foam gun upper body.

Another object of the present invention is to provide a spray foam gun cover for protecting a spray foam gun upper body from overspray that is form-fitted to the spray foam gun upper body of a respective type of spray foam gun.

Another object of the present invention is to provide a spray foam gun cover for protecting a spray foam gun upper body from overspray that is re-usable and allows removal of hardened overspray by bending and/or scraping the spray foam gun cover.

According to one aspect of the present invention, there is provided a spray gun cover for protecting a spray gun upper body from overspray. The spray gun cover comprises a cover front wall, a cover rear wall, and a cover center body. The cover front wall is form-fitted to a front portion of the spray gun upper body surrounding a spray nozzle of the spray gun and has a front aperture disposed therein such that the front aperture coincides with the spray nozzle. The cover rear wall is form-fitted to a rear portion of the spray gun upper body. The cover center body is disposed between the cover front wall and the cover rear wall and has a bottom aperture disposed in a bottom portion thereof. The bottom aperture is designed for enabling insertion of the spray gun upper body therethrough into the spray gun cover. The cover front wall, the cover rear wall, and the cover center body are sufficiently pliable and have a sufficient wall thickness for enabling application/removal of the spray gun cover onto/from the spray gun upper body and for ensuring a substantially tight fit: between the cover front wall and the front portion of the spray gun upper body; and between the cover rear wall and the rear portion of the spray gun upper body.

According to the aspect of the present invention, there is provided a method for protecting a spray gun upper body from overspray. A spray gun cover is provided. The spray gun upper body is inserted through the bottom aperture into the spray gun cover. The cover front wall or the cover rear wall is form-fitted to the respective front or rear portion of the spray gun upper body. The other of the cover front wall or the cover rear wall is form-fitted to the respective other front or rear portion of the spray gun upper body while the spray gun cover is stretched. The stretched spray gun cover is released. The cover front wall is substantially tightly fitted to the front portion of the spray gun upper body and the cover rear wall is substantially tightly fitted to the rear portion of the spray gun upper body.

According to the aspect of the present invention, there is provided a method for manufacturing a spray gun cover. A 3D scan of the spray gun is generated.

Based on the 3D scan, the cover front wall, the cover rear wall, and the cover center body are designed such that application/removal of the spray gun cover onto/from the spray gun upper body is enabled and a substantially tight fit is ensured. Mold components for a compression molding process are designed. The spray gun cover is produced by executing the compression molding process using the mold components and a pliable plastic material.

The advantage of the present invention is that it provides a spray foam gun cover for protecting a spray foam gun upper body from overspray that provides a substantially tight fit with the spray foam gun upper body.

A further advantage of the present invention is that it provides a spray foam gun cover for protecting a spray foam gun upper body from overspray that is form-fitted to the spray foam gun upper body of a respective type of spray foam gun.

A further advantage of the present invention is to provide a spray foam gun cover for protecting a spray foam gun upper body from overspray that is re-usable and allows removal of hardened overspray by bending and/or scraping the spray foam gun cover.

### BRIEF DESCRIPTION OF THE DRAWINGS

A preferred embodiment of the present invention is described below with reference to the accompanying drawings, in which:

FIGS. 1a and 1b are simplified block diagrams illustrating in a side perspective view and a bottom perspective view, respectively, a spray foam gun cover according to a preferred embodiment of the invention;

FIGS. 1c and 1d are simplified block diagrams illustrating in a top view and a bottom view, respectively, the spray foam gun cover according to a preferred embodiment of the invention;

FIGS. 1e and 1f are simplified block diagrams illustrating in a front view and a rear view, respectively, the spray foam gun cover according to a preferred embodiment of the invention; and,

FIGS. 2a and 2b are simplified block diagrams illustrating in a bottom view and a side view, respectively, the design stage of the spray foam gun cover according to a preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a GRACO Fusion' spray foam gun, it will become evident to those skilled in the art that the embodiments of the invention are not limited thereto, but are also adaptable for providing a cover for other spray foam gun models of the manufacturer ‘GRACO’, as well as spray foam gun models of other manufacturers or other spray guns such as, for example, paint spray guns.

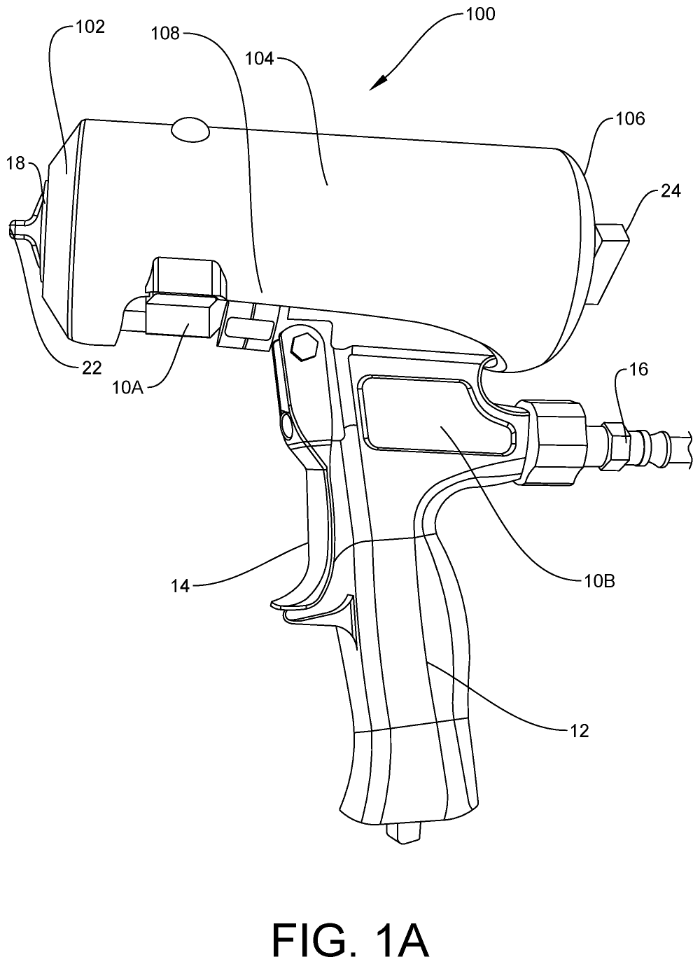

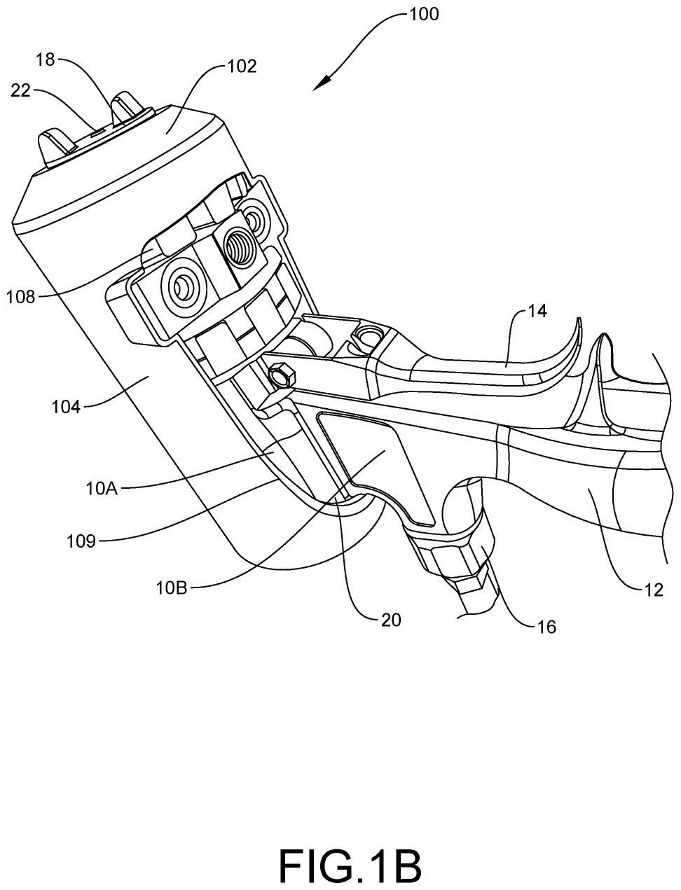

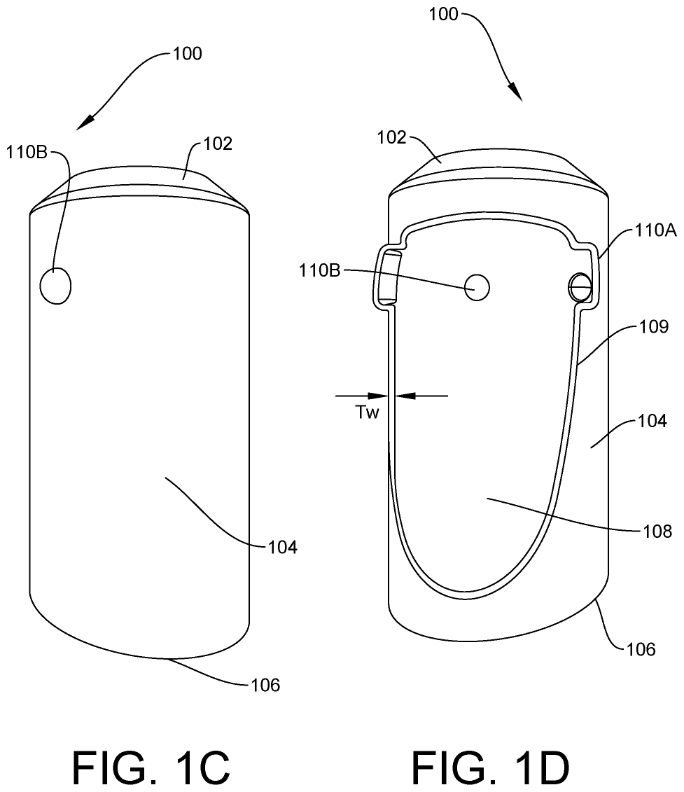

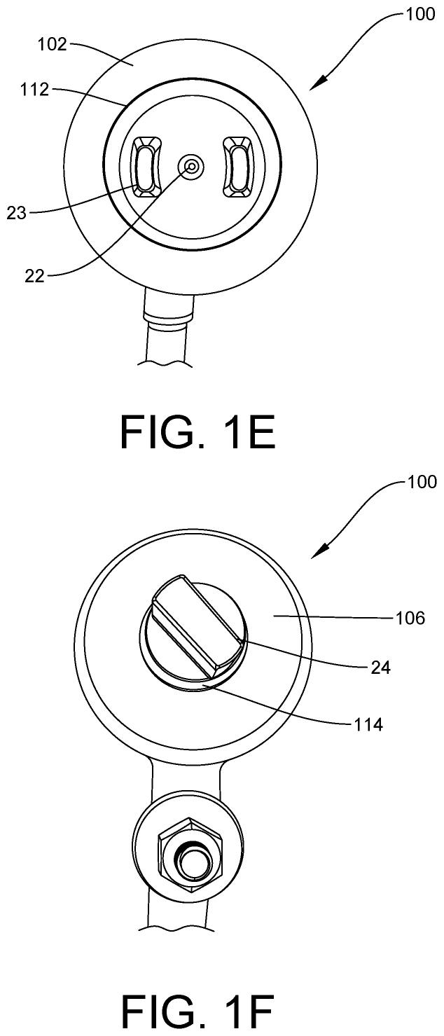

Referring to FIGS. 1a to 1f, a spray foam gun cover 100 according to a preferred embodiment of the invention is provided. The spray foam gun cover 100 is, preferably, designed to protect in a tight fit spray foam gun upper body 10A from overspray during the spraying process. It is noted that, typically, spray foam gun lower body 10B—comprising handle 12, trigger 14, and spray foam supply hose connector 16—is mostly protected by the spray foam technician's protective clothing, i.e. the gloves, when holding the spray foam gun handle 12 and activating trigger 14, while the spray foam gun upper body 10A is fully exposed to the overspray.

The spray foam gun cover 100 comprises cover front wall 102, cover rear wall 106, and cover center body 104. The cover front wall 102 is form-fitted to front portion 18 of the spray foam gun upper body 10A surrounding spray nozzle 22 and has front aperture 112 disposed therein which coincides with the spray nozzle 22, as illustrated in FIG. 1e. Preferably, the front aperture 112 is form-fitted to base 23 of the spray nozzle 22 for anchoring the cover front wall 102 thereto, in case the spray nozzle 22 is provided with a base, thus providing additional means of securement.

The cover rear wall 102 is form-fitted to rear portion 20 of the spray foam gun upper body 10A. Depending on the design of the spray foam gun upper body 10A, the cover rear wall 106 may have one or more control apertures 114 disposed therein for enabling access to one or more spray regulators 24, as illustrated in FIG. 1f. As is evident to one skilled in the art, apertures for enabling access to controls may be disposed at any location of the spray foam gun cover 100, depending on the design of the spray foam gun upper body 10A.

For example, the cover front wall 102 and the cover rear wall 106 are form-fitted such that at least a portion of the inside surface of each substantially conforms to a respective surface of the front portion 18 and the rear portion 20 when the cover is applied in a tight fit.

The cover center body 104 comprises bottom aperture 108 disposed in a bottom portion thereof. The bottom aperture 108 is designed such that insertion of the spray foam gun upper body 10A therethrough into the spray foam gun cover 100 is enabled. Preferably, the bottom aperture 108 is also designed such that its size is sufficiently small for providing sufficient protection of the bottom of the spray foam gun upper body 10A. Further preferably, the cover wall edge 109 surrounding the bottom aperture 108 is designed such that it is substantially aligned with the respective portion of the bottom of the spray foam gun upper body 10A for substantially preventing ingress of the overspray between the spray foam gun cover 100 and the spray foam gun upper body 10A.

It is noted, that the cover front wall 102, cover rear wall 106, and cover center body 104 may comprise bulges or protrusions 110A, 110B extending therefrom in order to conform to the shape of the spray foam gun upper body 10A. Furthermore, while the spray foam gun cover 100 illustrated in FIGS. 1a to 1f is of substantially cylindrical shape, it will become evident to those skilled in the art that the shape of the spray foam gun cover 100 is not limited thereto, but may be of any shape that conforms to the shape of the type of spray foam gun upper body 10A it is designed to cover.

The cover front wall 102, the cover rear wall 106, and the cover center body 104 are sufficiently pliable and have a sufficient wall thickness Tw for enabling application/removal of the spray foam gun cover 100 onto/from the spray foam gun upper body 10A and for ensuring a substantially tight fit: between the cover front wall 102 and the front portion 18 of the spray foam gun upper body 10A; and between the cover rear wall 106 and the rear portion 20 of the spray foam gun upper body 10A. The spray foam gun cover 100 is applied by: inserting the spray foam gun upper body 10A through the bottom aperture 108 into the spray foam gun cover 100; form-fitting the cover front wall 102 or the cover rear wall 106 to the respective front 18 or rear 20 portion of the spray gun upper body 10A; form-fitting the other of the cover front wall 102 or the cover rear wall 106 to the respective other front 18 or rear 20 portion of the spray foam gun upper body 10A while stretching the spray foam gun cover 100 as indicated by the block arrows in FIG. 1d; and, releasing the stretched spray foam gun cover 100. After release the cover front wall 102 fits substantially tightly to the front portion 18 of the spray foam gun upper body 10A and the cover rear wall 106 fits substantially tightly to the rear portion 20 of the spray foam gun upper body 10A.

The spray foam gun cover 100 is simply removed by: stretching the same as above; removing the cover front wall 102 or the cover rear wall 106 from the respective front 18 or rear 20 portion of the spray gun upper body 10A; releasing the stretched spray foam gun cover 100; removing the other of the cover front wall 102 or the cover rear wall 106 from the respective other front 18 or rear 20 portion of the spray foam gun upper body 10A; and, removing the spray foam gun upper body 10A through the bottom aperture 108 from the spray foam gun cover 100.

Preferably, the spray foam gun cover 100 is made of a material that provides sufficient pliability of the spray foam gun cover 100 while also having anti-adhesive properties and, further preferably, having abrasion resistant and impact resistant properties. These characteristics are achieved by using, for example, a silicone rubber material. Furthermore, producing the spray foam gun cover 100 with silicone rubber having wall thickness Tw between 1.5 mm and 2.5 mm, preferably, 2 mm, provides sufficient pliability while also protecting the spray foam gun upper body 10A when bumped, scratched or dropped, as well as allowing re-use of the spray foam gun cover 100. The anti-adhesive properties of the silicone rubber enable easy cleaning by simply wiping the overspray off the spray foam gun cover 100, while hardened overspray remains are simply removed by bending or scraping the spray foam gun cover 100.

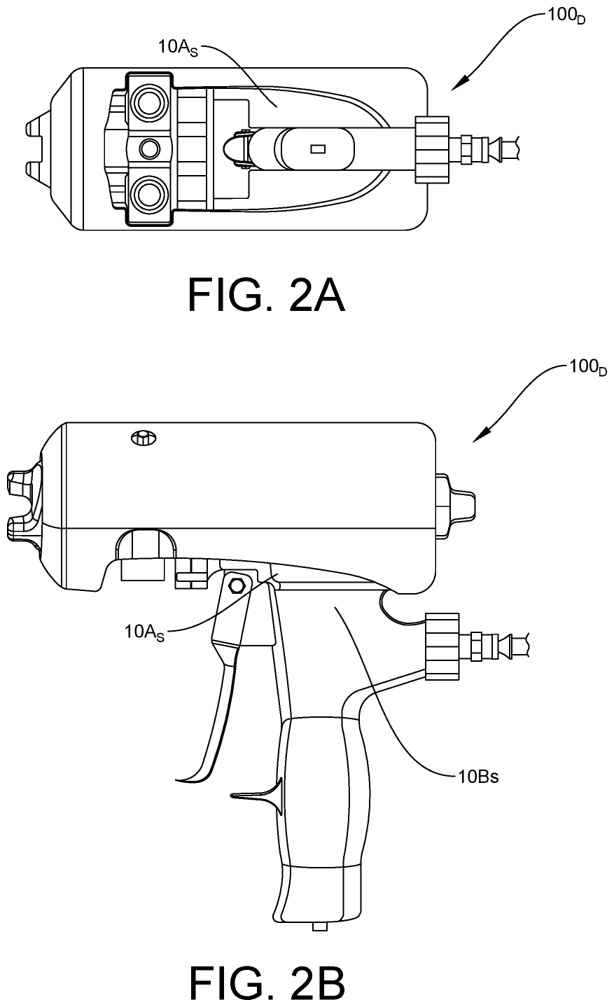

Referring to FIGS. 2a and 2b, the spray foam gun cover 100 is manufactured by generating a 3D scan 10A_{S} of the spray foam gun. Based on the 3D scan 10A_{S}, the cover front wall, the cover rear wall, and the cover center body of the spray foam gun cover 100 are designed—spray foam gun cover design 100_{D}—such that application/removal of the spray gun cover onto/from the spray gun upper body is enabled and a substantially tight fit is ensured. The design is performed using conventional Computer Aided Design (CAD) technology and data received from the 3D scan of the spray foam gun. Alternatively, CAD design data of the spray foam gun may be used when available. After the design of the spray foam gun cover 100 mold components—for example, a two-plate mold for producing the spray foam gun cover 100 using a conventional compression molding process—are designed using conventional CAD technology. The spray foam gun cover 100 is then produced by executing the compression molding process using the mold components and a pliable plastic material.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A spray gun cover for protecting a spray gun upper body from overspray comprising:
a cover front wall, the cover front wall being form-fitted to a front portion of the spray gun upper body surrounding a spray nozzle of the spray gun and having a front aperture disposed therein such that the front aperture coincides with the spray nozzle;
a cover rear wall, the cover rear wall being form-fitted to a rear portion of the spray gun upper body;
a cover center body disposed between the cover front wall and the cover rear wall, the cover center body having a bottom aperture disposed in a bottom portion thereof, the bottom aperture being designed for enabling insertion of the spray gun upper body therethrough into the spray gun cover; and,
wherein the cover front wall, the cover rear wall, and the cover center body are sufficiently pliable and have a sufficient wall thickness for enabling application/removal of the spray gun cover onto/from the spray gun upper body and for ensuring a substantially tight fit: between the cover front wall and the front portion of the spray gun upper body; and between the cover rear wall and the rear portion of the spray gun upper body.

2. The spray gun cover according to claim 1 wherein the spray gun cover is made of a material having anti-adhesive properties.

3. The spray gun cover according to claim 2 wherein the spray gun cover is made of a material having abrasion resistant and impact resistant properties.

4. The spray gun cover according to claim 3 wherein the spray gun cover is made of a silicone rubber material.

5. The spray gun cover according to claim 4 wherein the spray gun cover has a wall thickness between 1.5 mm and 2.5 mm.

6. The spray gun cover according to claim 5 wherein the spray gun cover has a wall thickness of approximately 2 mm.

7. The spray gun cover according to claim 1 wherein the spray gun cover is designed for form-fitting a spray foam gun.

8. The spray gun cover according to claim 7 wherein the spray gun cover is designed for form-fitting a GRACO spray foam gun.

9. The spray gun cover according to claim 1 comprising at least a control aperture disposed therein for enabling access to at least a spray regulator.

10. The spray gun cover according to claim 1 wherein the front aperture is form-fitted to a base of the spray nozzle for anchoring the cover front wall thereto.

11. A method for protecting a spray gun upper body from overspray comprising:
providing the spray gun cover according to claim 1;
inserting the spray gun upper body through the bottom aperture into the spray gun cover;
form-fitting the cover front wall or the cover rear wall to the respective front or rear portion of the spray gun upper body;
form-fitting the other of the cover front wall or the cover rear wall to the respective other front or rear portion of the spray gun upper body while stretching the spray gun cover;
releasing the stretched spray gun cover; and,
substantially tightly fitting the cover front wall to the front portion of the spray gun upper body and the cover rear wall to the rear portion of the spray gun upper body.

12. The method according to claim 11 comprising:
removing the spray gun cover from the spray gun upper body; and,
removing the overspray from the spray gun cover by bending scraping the same.

13. A method for manufacturing the spray gun cover according to claim 1 comprising:
generating a 3D scan of the spray gun;
based on the 3D scan, designing the cover front wall, the cover rear wall, and the cover center body such that application/removal of the spray gun cover onto/from the spray gun upper body is enabled and a substantially tight fit is ensured;
designing mold components for a compression molding process; and,
producing the spray gun cover by executing the compression molding process using the mold components and a pliable plastic material.

14. The method according to claim 13 wherein the spray gun cover is produced using a silicone rubber material.

15. The method according to claim 13 wherein the mold components are designed to provide a two-plate mold.
